(19) United States
(12) Patent Application Publication
(10) Pub. No.: US 2015/0026258 A1
(43) Pub. Date: Jan. 22, 2015

(54) METHOD AND APPARATUS FOR DETERMINING PARTICIPANT DISCOVERY MESSAGE PERIOD

(71) Applicant: Electronics and Telecommunications Research Institute, Daejeon (KR)

(72) Inventors: Jeman PARK, Seoul (KR); Soohyung LEE, Daejeon (KR); Hyungkook JUN, Seoul (KR); Kyungil KIM, Daejeon (KR); Kyeongtae KIM, Daejeon (KR); Wontae KIM, Asan (KR)

(73) Assignee: Electronics and Telecommunications Research Institute, Daejeon (KR)

(21) Appl. No.: 14/104,895

(22) Filed: Dec. 12, 2013

(30) Foreign Application Priority Data
Jul. 17, 2013 (KR) 10-2013-0083984

(51) Int. Cl. H04L 29/06

(52) U.S. Cl. CPC H04L 65/403
USPC 709/204

(57) ABSTRACT

Disclosed herein is a method and apparatus for determining a participant discovery message period, which can adjust the period of domain participant discovery messages in consideration of variability in network and the importance of participants. The apparatus includes a network stability ratio calculation unit for calculating a network stability ratio based on a domain leave rate of participants. A participant discovery message period calculation unit calculates a participant discovery message period depending on a variation in network status based on the network stability ratio. A priority analysis unit analyzes preset priorities of participants. A participant discovery message period determination unit determines a participant discovery message period based on both the participant discovery message period depending on the variation in network status and the participant priorities.

### CROSS REFERENCE TO RELATED APPLICATION

This application claims the benefit of Korean Patent Application No. 10-2013-0083984, filed on Jul. 17, 2013, which is hereby incorporated by reference in its entirety into this application.

### BACKGROUND OF THE INVENTION

1. Technical Field

The present invention relates generally to a method and apparatus for determining a participant discovery message period in Data Distribution Service (DDS) middleware communication and, more particularly, to a method and apparatus for determining the period of a message required to search for domain participants in DDS middleware communication based on a publish/subscribe scheme.

2. Description of the Related Art

Recently, in a large-scale network for various application programs, a server/client scheme corresponding to an existing 1:N communication scheme exhibits various limitations.

Accordingly, research into data-centric communication technology for collecting and distributing data over a network has been conducted. Recently, interest in data-centric communication middleware, that is, Data Distribution Service (DDS), has increased.

DDS middleware is communication middleware defined as a standard by Object Management Group (OMG), and is configured to exchange data between pieces of middleware based on a publish/subscribe scheme. DDS is configured such that an unspecified number of publishers and subscribers participate in a network, and the subscribers subscribe to information published by publishers, thus enabling data to be exchanged. Messages that are exchanged are directly transferred between publishers and subscribers without passing through a separate server. Therefore, a publish/subscribe model is suitable for systems in which data communication simultaneously occurs on a large number of terminals and in which data exchange requiring real-time properties frequently occurs.

However, a discovery technique for discovering participants in existing publish/subscribe communication is limited in that messages are periodically transmitted so as to notify all participants of participation or non-participation, and thus there is a limitation in extensively applying such a technique to large-scale systems.

In DDS middleware communication based on the conventional publish/subscribe scheme, N*(N-1) periodic messages are transmitted to search for domain participants. This directly influences the overall performance of the system as the number of nodes (N) increases. Therefore, in a large-scale network, the period of domain participant discovery messages must be flexibly changed.

Prior art related to this includes technology disclosed in Korean Patent Application Publication No. 2012-0071576 (entitled “Distributed Hash Table (DHT)-based Real-Time Publish-Subscribe (RTPS) discovery method, apparatus, and system”) in which a P2P participant peer provided on an RTPS participant can rapidly acquire the location information of another RTPS participant via the Distributed Hash Table (DHT) of an overlay network and can perform a Simple Participant Discovery Protocol (SPDP) operation using unicast transmission.

According to Korean Patent Application Publication No. 2012-0071576, there is no need to frequently exchange data for RTPS discovery in a domain unlike conventional technology which performs a multicast-type SPDP operation, and it is possible to rapidly and efficiently operate a network.

However, the invention disclosed in Korean Patent Application Publication No. 2012-0071576 is problematic in that a complicated algorithm such as a DHT technique is included, thus making it difficult to actually develop such technology.

### SUMMARY OF THE INVENTION

Accordingly, the present invention has been made keeping in mind the above problems occurring in the prior art, and an object of the present invention is to provide a method and apparatus for determining a participant discovery message period, which can adjust the period of domain participant discovery messages in consideration of variability in network and the importance of participants.

In accordance with an aspect of the present invention to accomplish the above object, there is provided a method of determining a participant discovery message period, including calculating, by a network stability ratio calculation unit, a network stability ratio based on a domain leave rate of participants; calculating, by a participant discovery message period calculation unit, a participant discovery message period depending on a variation in network status based on the network stability ratio; analyzing, by a priority analysis unit, preset priorities of participants; and determining, by a participant discovery message period determination unit, a final participant discovery message period based on both the participant discovery message period depending on the variation in network status and the participant priorities.

Preferably, calculating the network stability ratio may include receiving information about joining and leaving of one or more other participants in and from a domain from a Data Distribution Service (DDS) network; and calculating the network stability ratio based on a domain leave rate of the participants generated based on the information about the joining and leaving of the one or more other participants in and from the domain.

Preferably, calculating the participant discovery message period depending on the variation in network status may be configured to perform an operation on the network stability ratio and a value of a preset default participant discovery message period and to determine a resulting value of the operation to be the participant discovery message period depending on the variation in network status.

Preferably, calculating the participant discovery message period depending on the variation in network status may be configured to determine a resulting value, obtained by multiplying the network stability ratio by a value of a preset default participant discovery message period, to be the participant discovery message period depending on the variation in network status until the domain leave rate of the participants reaches a preset first threshold.

Preferably, calculating the participant discovery message period depending on the variation in network status may be configured to, if the domain leave rate of the participants is present between the first threshold and a preset second threshold, determine a resulting value, obtained by adding the value of the preset default participant discovery message period to the network stability ratio, to be the participant discovery message period depending on the variation in network status.

Preferably, calculating the participant discovery message period depending on the variation in network status may be configured to, if the domain leave rate of the participants reaches the second threshold, determine the second threshold to be the participant discovery message period depending on the variation in network status.

Preferably, calculating the participant discovery message period depending on the variation in network status may be configured to, if the domain leave rate of the participants exceeds the second threshold, determine the value of the preset default participant discovery message period to be the participant discovery message period depending on the variation in network status.

Preferably, determining the final participant discovery message period may be configured to determine a resulting value, obtained by multiplying the calculated participant discovery message period depending on the variation in network status by the participant priorities, to be the final participant discovery message period.

In accordance with another aspect of the present invention to accomplish the above object, there is provided an apparatus for determining a participant discovery message period, including a network stability ratio calculation unit for calculating a network stability ratio based on a domain leave rate of participants; a participant discovery message period calculation unit for calculating a participant discovery message period depending on a variation in network status based on the network stability ratio; a priority analysis unit for analyzing preset priorities of participants; and a participant discovery message period determination unit for determining a final participant discovery message period based on both the participant discovery message period depending on the variation in network status and the participant priorities.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of a DDS network to which the present invention is applied;

FIG. 2 is a configuration diagram of an apparatus for determining a participant discovery message period according to an embodiment of the present invention;

FIG. 3 is a graph showing a variation in a participant discovery message period depending on a variation in network status applied to the embodiment of the present invention; and

FIG. 4 is a flowchart showing a method of determining a participant discovery message period according to an embodiment of the present invention.

### DESCRIPTION OF THE PREFERRED EMBODIMENTS

Hereinafter, a method and apparatus for determining a participant discovery message period according to embodiments of the present invention will be described in detail with reference to the attached drawings. Prior to the detailed description of the present invention, it should be noted that the terms or words used in the present specification and the accompanying claims should not be limitedly interpreted as having their common meanings or those found in dictionaries. Therefore, the embodiments described in the present specification and constructions shown in the drawings are only the most preferable embodiments of the present invention, and are not representative of the entire technical spirit of the present invention. Accordingly, it should be understood that various equivalents and modifications capable of replacing the embodiments and constructions of the present invention might be present at the time at which the present invention was filed.

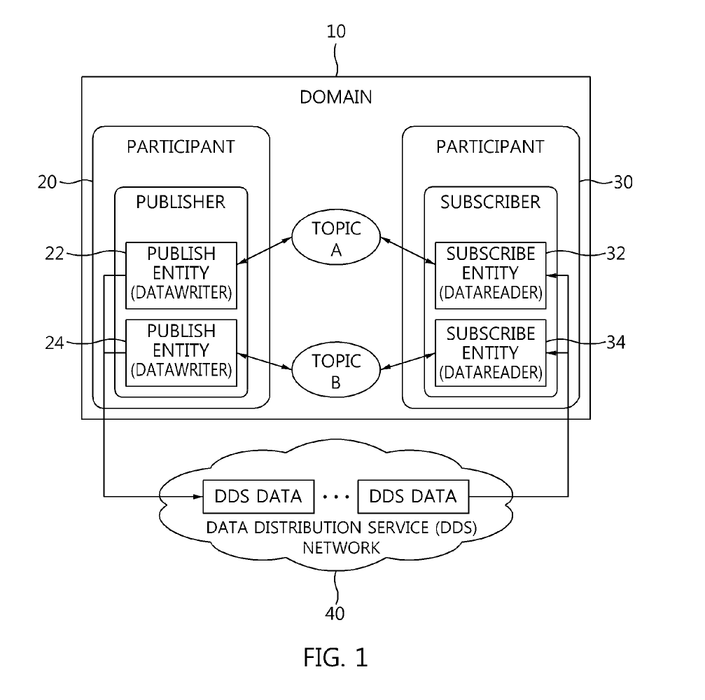

FIG. 1 is a diagram showing the configuration of a Data Distribution Service (DDS) network to which the present invention is applied.

The DDS network is identified by a domain 10 which is a data-sharing area. The domain 10 includes one or more participants 20 and 30.

Each of the participants 20 and 30 may include one or more publishers or subscribers. A publisher may include one or more publish entities 22 and 22 so as to transfer its own information, and a subscriber may include one or more subscribe entities 32 and 34 so as to receive information from the corresponding publisher.

An application generates a topic indicating the theme of specific data and registers the topic as a topic of interest in the publish entities 22 and 24 and the subscribe entities 32 and 34, and thus the publish entities 22 and 24 and the subscribe entities 32 and 34 exchange information with each other. Since a publisher and a subscriber having different topics of interest do not exchange topic information, interference does not occur between them. That is, the DDS network has a peer-to-peer structure in which a server is not present, wherein, among all the network participants 20 and 30, only individual participants having the same topic communicate with each other. Information corresponding to the topic of interest is transmitted as a “DDS data” packet through the publish entities 22 and 24 and a DDS network 40. The subscribe entities 32 and 34 check topic information contained in the received “DDS data” packet and transfers information to the application.

DDS middleware may be chiefly classified into a Data-Centric Publish-Subscribe (DCPS) layer and a layer using a Real-Time Publish-Subscribe (RTPS) protocol. The DCPS layer, which is a middleware interface having specifications of publish/subscribe for distributed environment, provides a standardized interface for a data-centric publish-subscribe programming model for distributed environment. The layer using the RTPS protocol, which is a layer in which actual data is published and subscribed to, provides the function of forming a domain, determining the type of data to be used, and dynamically discovering remote participants participating in the domain.

Actual data is published and subscribed to by publishers and subscribers in the DCPS layer, and reliable or unreliable data communication is performed depending on Quality of Service (QoS) set by the DCPS layer.

In FIG. 1, each participant 20 or 30 functions as a Real-Time Publish-Subscribe (RTPS) communication object, and may be regarded as a network node. Each participant 20 or 30 may be any one of various types of terminal devices, such as a mobile phone, a smart phone, a laptop computer, a fixed computer, and a set-top box. For example, the participant 20 may transmit a discovery message in a unicast or multicast manner so as to discover the participant 30 participating in the domain 10. This procedure is called a participant discovery procedure. A participant discovery message (also referred to as a “participant detection message”) may include information about a protocol version, a vendor identifier, unicast and multicast locators (transfer address, port number, etc.), a method of tracking a participant, etc. In this way, each participant 20 or 30 may discover a participant belonging to the same domain 10 by transferring and exchanging each participant discovery message over the network. If the participant discovery procedure has been completed, each participant 20 or 30 performs an endpoint discovery procedure for checking the QoS information of DataWriter or DataReader which is a communication entity that actually performs the transmission of topic data within the corresponding participant and for exchanging the QoS information.

Meanwhile, the application layer of each participant 20 or 30 provides the priority of the participant (also referred to as “participant importance information”) suitable for the application environment of the corresponding participant depending on the application environment of the participant. Here, the participant priority may be represented by a value or a grade, but is not limited thereto. If it is assumed that the priority of each participant 20 or 30 is represented by the grade of priority, a priority grade may be determined using at least one of a plurality of pieces of QoS information generated by the DCPS layer of the DDS middleware. The QoS information may include various types of information, for example, deadline, reliability, user data, topic data, and lifespan. In the embodiment of the present invention, the user is assumed to be capable of previously determining the priorities of participants. In detail, it is assumed that the priority (importance) of data possessed by the participants (for example, topic data) may be previously determined Of course, the priorities of respective participants previously determined by the user may be combined into a single user policy (also called a QoS policy). Consequently, pieces of priority information for a plurality of participants may be recorded in a single user policy. Therefore, in the embodiment of the present invention, each participant priority Participant_Priority may be provided directly by the user or may be defined using set QoS values.

The DDS network may dynamically generate an unspecified number of publishers and subscribers, and may determine priorities using QoS applied to the dynamic generation of publishers and subscribers. Therefore, the priorities of the respective participants 20 and 30 may be dynamically determined

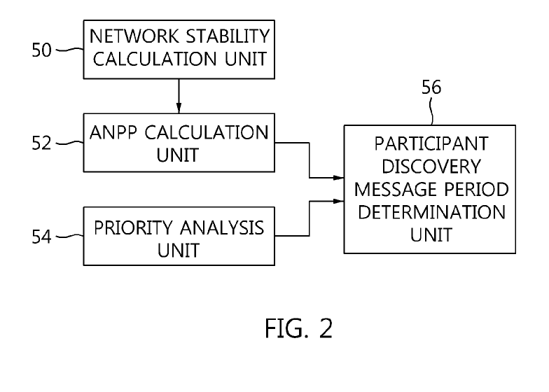

FIG. 2 is a configuration diagram of an apparatus for determining a participant discovery message period according to an embodiment of the present invention, and

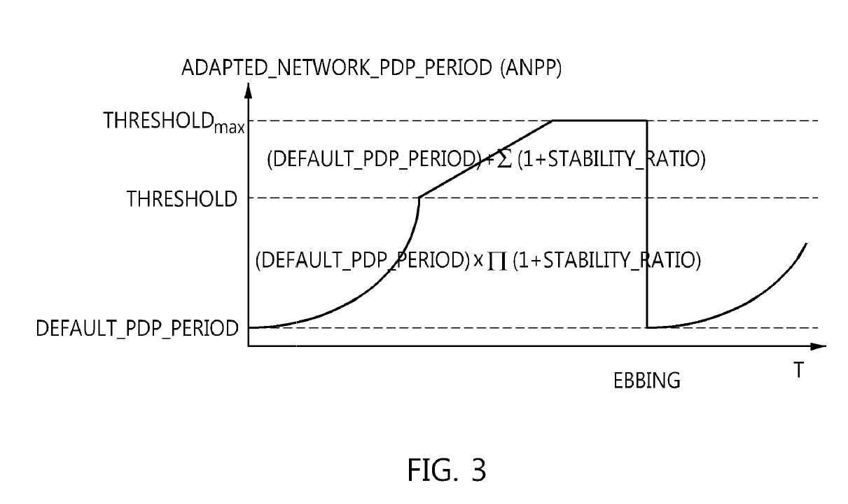

FIG. 3 is a graph showing a variation in a participant discovery message period depending on a variation in network status applied to the embodiment of the present invention. The apparatus for determining the participant discovery message period shown in FIG. 2 may be installed in each of the participants 20 and 30.

The apparatus for determining the participant discovery message period according to the embodiment of the present invention includes a network stability calculation unit 50, an Adapted_Network_PDP_Period (ANPP) calculation unit 52, a priority analysis unit 54, and a participant discovery message period determination unit 56.

The network stability calculation unit 50 calculates network stability based on the rate of participants leaving the domain. That is, the network stability calculation unit 50 receives information about the joining and leaving of one or more other participants in and from the domain from the DDS network 40. Further, the network stability calculation unit 50 generates the rate of participants leaving the domain (or domain leave rate of participants), based on the information about the joining and leaving of the one or more other participants in and from the domain, and calculates network stability ratio using the generated domain leave rate of the participants.

The network stability calculation unit 50 may calculate the network stability ratio using the following Equation (1):

Stability_Ratio=(1−Leave_Participant/Total_Participant) (1)

where Leave_Participant denotes the number of participants leaving the domain 10 during an interval from the arrival of a previous participant discovery message period PDP_Period to the arrival of a current participant discovery message period PDP_Period. Total Participant denotes the total number of participants joining the domain 10 during the interval from the arrival of the previous participant discovery message period PDP_Period to the arrival of the current participant discovery message period PDP_Period. Therefore, Leave_Participant/Total_Participant denotes the rate of participants leaving the domain during the interval from the arrival of the previous participant discovery message period PDP_Period to the arrival of the current participant discovery message period PDP_Period.

The ANPP calculation unit 52 calculates a participant discovery message period Adapted_Network_PDP_Period depending on a variation in network status, based on the network stability ratio Stability_Ratio calculated by the network stability calculation unit 50.

In greater detail, the ANPP calculation unit 52 obtains a participant discovery message period depending on a variation in network status using the values of the network stability ratio Stability_Ratio and a preset default participant discovery message period Default_PDP_Period. That is, the ANPP calculation unit 52 may calculate the participant discovery message period Adapted_Network_PDP_Period depending on the variation in network status using different operation methods within the range of a preset first threshold and a preset second threshold thresholdₘₐₓ. For example, the second threshold thresholdₘₐₓ may be set to a value at which the domain leave rate of participants corresponds to about 30%, and the first threshold may be set to a value between the values of the preset default participant discovery message period DefaultPDP_Period (see FIG. 3) and the second threshold thresholdₘₐₓ.

Preferably, the ANPP calculation unit 52 sets a resulting value obtained by multiplying the network stability ratio Stability_Ratio by the value of the preset default participant discovery message period Default_PDP_Period to the participant discovery message period Adapted_Network_PDP_Period depending on the variation in network status until the domain leave rate of participants reaches the first threshold (see FIG. 3). That is, the ANPP calculation unit 52 defines the participant discovery message period Adapted_Network_PDP_Period depending on the variation in network status by multiplying the network stability ratio Stability_Ratio by the value of the preset default participant discovery message period DefaultPDP_Period, as given by the following Equation (2), until the first threshold preset by the user using the ratio of the leaving of participants from the domain is reached, so that the variation in network status is exponentially reflected, and thus the period is rapidly increased. This results in the effect of reducing an overhead by increasing a participant discovery message period after a new participant has joined the network (that is, joined the domain).

Adapted_Network_PDP_period=Default_PDP_{—} period×Π(1+Stability_Ratio) (2)

Meanwhile, the ANPP calculation unit 52 is configured to, if the domain leave rate of participants is present between the first threshold and the preset second threshold thresholdₘₐₓ, set a resulting value obtained by adding the value of the preset default participant discovery message period Default_PDP_Period to the network stability ratio Stability_Ratio to the participant discovery message period Adapted_Network_PDP_Period depending on the variation in network status. That is, if the domain leave ratio of participants becomes greater than the first threshold, the ANPP calculation unit 52 prevents the participant discovery message period Adapted_Network_PDP_Period depending on the variation in network status from excessively rapidly increasing by linearly increasing the corresponding period Adapted_Network_PDP_Period. This may be defined by the following Equation (3):

Adapted_Network_PDP_period=Default_{—} PDP_{—} period +Σ(1+Stability_Ratio) (3)

Further, the ANPP calculation unit 52 is configured to, if the domain leave rate of participants reaches the second threshold thresholdₘₐₓ, set the second threshold thresholdₘₐₓ to the participant discovery message period Adapted_Network_PDP_Period depending on the variation in network status. The reason for this is to prevent the reliability of participant information from decreasing due to an excessive increase in the participant discovery message period Adapted_Network_PDP_Period depending on the variation in network status. For this, the second threshold thresholdₘₐₓ is defined and is used to limit the value of the participant discovery message period Adapted_Network_PDP_Period depending on the variation in network status (See FIG. 3).

Meanwhile, the ANPP calculation unit 52 is configured to, if the domain leave rate of participants exceeds the second threshold thresholdₘₐₓ, set the value of the preset default participant discovery message period Default_PDP_Period to the participant discovery message period Adapted_Network_PDP_Period depending on the variation in network status. The reason for this is to improve the reliability of participant information by rapidly sending a participant discovery message when the domain leave rate (also referred to as the “network leave rate”) of participants rapidly increases. For this operation, the participant discovery message period Adapted_Network_PDP_Period depending on the variation in network status is restored to the preset default participant discovery message period DefaultPDP_Period (see FIG. 3). That is, during an ebbing period in which the leave rate of participants rapidly increases, the participant discovery message period is restored to the default participant discovery message period Default PDP Period so as to rapidly restore participant information.

The above-described ANPP calculation unit 52 may be understood to be a participant discovery message period calculation unit described in the accompanying claims of the present invention.

In FIG. 2, the priority analysis unit 54 analyzes preset priorities of participants. As described above with reference to FIG. 1, the embodiment of the present invention may previously determine the priorities of a plurality of participants and may record information about the priorities of the participants in a user policy. Therefore, the priority analysis unit 54 may analyze the preset participant priorities based on the participant priorities previously determined by the user or the priority information of the user policy.

The participant discovery message period determination unit 56 determines a final participant discovery message period PDP_Period based on both the participant discovery message period Adapted_Network_PDP_Period depending on the variation in network status, output from the ANPP calculation unit 52, and the participant priorities Participant_Priority output from the priority analysis unit 54. That is, the participant discovery message period determination unit 56 determines a resulting value obtained by multiplying the calculated participant discovery message period Adapted_Network_PDP_Period depending on the variation in network status by the participant priorities Participant_Priority to be the final participant discovery message period PDP_Period. In other words, in the Data Distribution Service (DDS) of Object Management Group (OMG) which is a representative one of publish/subscribe communication-based middleware API, a Simple Participant Discovery Protocol (SPDP) is used to determine whether all participants in the domain have joined the domain and to search for participants. The SPDP is designed to be periodically transmitted by all participants. Therefore, in the embodiment of the present invention, the period PDP_Period during which a participant discovery message required to determine whether all participants in the domain have joined the domain and to search for participants is transmitted is determined to be a resulting value obtained by multiplying the participant discovery message period Adapted_Network_PDP_Period depending on the variation in network status by the participant priorities Participant_Priority.

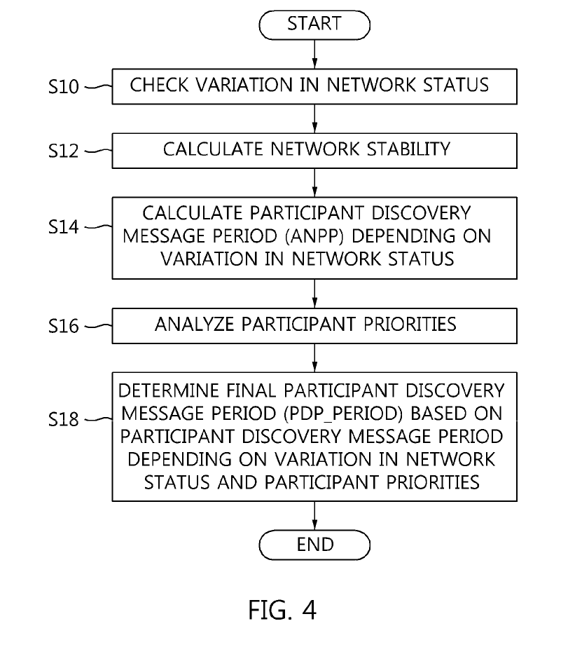

FIG. 4 is a flowchart showing a method of determining a participant discovery message period according to an embodiment of the present invention.

First, the network stability calculation unit 50 receives information about the joining and leaving of one or more other participants in and from the domain from the DDS network 40 so as to check the variation in network status at step S10.

Next, the network stability calculation unit 50 generates the domain leave rate of participants based on the domain join and leave information of the other participants. Further, the network stability calculation unit 50 calculates a network stability ratio Stability_Ratio using the generated domain leave rate of the participants at step S12. The network stability calculation unit 50 transmits the calculated network stability ratio Stability_Ratio to the ANPP calculation unit 52.

Accordingly, the ANPP calculation unit 52 calculates a participant discovery message period Adapted_Network_PDP_Period depending on the variation in network status, based on the received network stability ratio at step S14.

Meanwhile, during the performance of the procedure at steps S10 to S14, the priority analysis unit 54 analyzes the preset priorities of the participants at step S16. Although an example in which step S16 is performed subsequent to the procedure of steps S10 to S14 has been shown in FIG. 4, steps S10 to S14 and step S16 are actually performed as separate procedures.

Finally, the participant discovery message period determination unit 56 determines a final participant discovery message period PDP Period based on the participant discovery message period Adapted_Network_PDP_Period depending on the variation in network status, output from the ANPP calculation unit 52, and the participant priorities Participant_Priority output from the priority analysis unit 54 at step S18.

In the above description, although the present invention has been described as being applied to a large-scale DDS middleware network system without having a server, it may be applied to a network including a plurality of sensor nodes, general wired/wireless networks, military action using a large-scale network, Ubiquitous-agriculture (U-agriculture), a home network, a meteorological system, large-scale monitoring using sensor nodes, etc.

In accordance with the present invention having the configuration, the period of participant discovery messages is changed by a variation in network status and the importance of participants, and thus an overhead caused by control messages can be greatly reduced over the entire system.

Since the importance information of participants is reflected, the real-time transfer of data to participants requiring real-time properties may be guaranteed. That is, the present invention is very effective in the stability and real-time properties upon discovering participants.

In particular, the period of participant discovery messages is flexibly changed depending on the status of a network, and thus the number of discovery messages occurring on the network is reduced. By means of this, network congestion is prevented, and thus participants may be rapidly searched for.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A method of determining a participant discovery message period, comprising:
calculating, by a network stability ratio calculation unit, a network stability ratio based on a domain leave rate of participants;
calculating, by a participant discovery message period calculation unit, a participant discovery message period depending on a variation in network status based on the network stability ratio;
analyzing, by a priority analysis unit, preset priorities of participants; and
determining, by a participant discovery message period determination unit, a final participant discovery message period based on both the participant discovery message period depending on the variation in network status and the participant priorities.

2. The method of claim 1, wherein calculating the network stability ratio comprises:
receiving information about joining and leaving of one or more other participants in and from a domain from a Data Distribution Service (DDS) network; and
calculating the network stability ratio based on a domain leave rate of the participants generated based on the information about the joining and leaving of the one or more other participants in and from the domain.

3. The method of claim 1, wherein calculating the participant discovery message period depending on the variation in network status is configured to perform an operation on the network stability ratio and a value of a preset default participant discovery message period and to determine a resulting value of the operation to be the participant discovery message period depending on the variation in network status.

4. The method of claim 1, wherein calculating the participant discovery message period depending on the variation in network status is configured to determine a resulting value, obtained by multiplying the network stability ratio by a value of a preset default participant discovery message period, to be the participant discovery message period depending on the variation in network status until the domain leave rate of the participants reaches a preset first threshold.

5. The method of claim 4, wherein calculating the participant discovery message period depending on the variation in network status is configured to, if the domain leave rate of the participants is present between the first threshold and a preset second threshold, determine a resulting value, obtained by adding the value of the preset default participant discovery message period to the network stability ratio, to be the participant discovery message period depending on the variation in network status.

6. The method of claim 5, wherein calculating the participant discovery message period depending on the variation in network status is configured to, if the domain leave rate of the participants reaches the second threshold, determine the second threshold to be the participant discovery message period depending on the variation in network status.

7. The method of claim 6, wherein calculating the participant discovery message period depending on the variation in network status is configured to, if the domain leave rate of the participants exceeds the second threshold, determine the value of the preset default participant discovery message period to be the participant discovery message period depending on the variation in network status.

8. The method of claim 1, wherein determining the final participant discovery message period is configured to determine a resulting value, obtained by multiplying the calculated participant discovery message period depending on the variation in network status by the participant priorities, to be the final participant discovery message period.

9. An apparatus for determining a participant discovery message period, comprising:
a network stability ratio calculation unit for calculating a network stability ratio based on a domain leave rate of participants;
a participant discovery message period calculation unit for calculating a participant discovery message period depending on a variation in network status based on the network stability ratio;
a priority analysis unit for analyzing preset priorities of participants; and
a participant discovery message period determination unit for determining a final participant discovery message period based on both the participant discovery message period depending on the variation in network status and the participant priorities.

10. The apparatus of claim 9, wherein the network stability ratio calculation unit receives information about joining and leaving of one or more other participants in and from a domain from a Data Distribution Service (DDS) network, and calculates the network stability ratio based on a domain leave rate of the participants generated based on the information about the joining and leaving of the one or more other participants in and from the domain.

11. The apparatus of claim 9, wherein the participant discovery message period calculation unit performs an operation on the network stability ratio and a value of a preset default participant discovery message period and to determine a resulting value of the operation to be the participant discovery message period depending on the variation in network status.

12. The apparatus of claim 9, wherein the participant discovery message period calculation unit calculates the participant discovery message period depending on the variation in network status is configured to determine a resulting value, obtained by multiplying the network stability ratio by a value of a preset default participant discovery message period, to be the participant discovery message period depending on the variation in network status until the domain leave rate of the participants reaches a preset first threshold.

13. The apparatus of claim 12, wherein the participant discovery message period calculation unit is configured to, if the domain leave rate of the participants is present between the first threshold and a preset second threshold, determine a resulting value, obtained by adding the value of the preset default participant discovery message period to the network stability ratio, to be the participant discovery message period depending on the variation in network status.

14. The apparatus of claim 13, wherein the participant discovery message period calculation unit is configured to, if the domain leave rate of the participants reaches the second threshold, determine the second threshold to be the participant discovery message period depending on the variation in network status.

15. The apparatus of claim 14, wherein the participant discovery message period calculation unit is configured to, if the domain leave rate of the participants exceeds the second threshold, determine the value of the preset default participant discovery message period to be the participant discovery message period depending on the variation in network status.

16. The apparatus of claim 9, wherein the participant discovery message period determination unit determines a resulting value, obtained by multiplying the calculated participant discovery message period depending on the variation in network status by the participant priorities, to be the final participant discovery message period.
